(19) United States
(12) Patent Application Publication
(10) Pub. No.: US 2016/0003693 A1
(43) Pub. Date: Jan. 7, 2016

(54) POWER DETERMINATION METHOD AND TURBOMACHINE

(71) Applicant: SIEMENS AKTIENGESELISCHAFT, München (DE)

(72) Inventor: Thomas Thiemann, Recklinghausen (DE)

(73) Assignee: SIEMENS AKTIENGESELLSCHAFT, Munich (DE)

(21) Appl. No.: 14/770,248

(22) PCT Filed: Jan. 31, 2014
(86) PCT No.: PCT/EP2014/051875

§ 371 Date: Aug. 25, 2015

(30) Foreign Application Priority Data
Feb. 27, 2013 (EP) 13156884.2

(51) Int. Cl. G01L 3/24; F01D 17/06; F01D 17/04; G01M 15/14; F01D 25/24

(52) U.S. Cl. CPC G01L 3/242; G01M 15/14; F01D 25/24; F01D 17/04; F01D 17/06; F05D 2220/31; F05D 2260/80

(57) ABSTRACT

A method determines a power of a turbomachine which has, in the interior thereof, a turbine housing which is supported with respect to a torque. The method includes current bearing forces of the turbine housing that are first of all determined and differences from stored permanent bearing forces that are then formed. The torque is then determined as the sum of these differences and the power of the turbomachine is determined therefrom.

### CROSS REFERENCE TO RELATED APPLICATIONS

This application is the US National Stage of International Application No. PCT/EP2014/051875 filed 31 Jan. 2014, and claims the benefit thereof. The International Application claims the benefit of European Application No. EP13156884 filed 27 Feb. 2013. All of the applications are incorporated by reference herein in their entirety.

### FIELD OF INVENTION

The present invention relates to a method for determining a power of a turbomachine, and to a turbomachine.

### BACKGROUND OF INVENTION

In the prior art, a power of, in particular, low-pressure turbines in turbo sets cannot be measured directly, in particular if said turbines are arranged in a shaft train with further turbines. The determination of power must then be performed by way of a power balance of the other components of the turbo set. The known power determination is thus subject to a certain level of inaccuracy.

GB 2 107 887 A discloses a torque measurement means for measuring a torque of a component. The torque measurement means comprises a pair of first connecting bars which, by one end, are pivotably connected to a fixed structure and, by the other end, are connected to a load transducer. A pair of second connecting bars are, by one end, pivotably connected to the component and, by the other end, are pivotably connected to the first connecting bars at a point between the ends of the first connecting bars, so as to transmit the torque to the transducer. The connecting bars are formed in a symmetrical arrangement relative to a common plane.

DE 198 29 178 A1 presents a method and a device for power determination and for power regulation in a plant, in particular in a single-shaft combined gas and steam turbine plant. Here, power determination within a drive input is performed in each case by virtue of operating variables within the drive input being determined. Power determination within a drive output is performed by virtue of operating variables within the drive output being determined. For the detection of strains caused by torsion, measurement sensors are provided along the shaft trains that connect the drive inputs to the drive output. The measurement signals from said measurement sensors in combination with the rotational speed and the internally obtained operating variables are used for determining an actual power of the plant as a whole. The determined actual power of the plant is compared with the target power, and the drives are controlled for targeted power variation in a manner dependent on the target/actual comparison.

U.S. Pat. No. 4,313,341 A discloses a torque measurement system for internal combustion engines. In this case, a pressure measurement device is arranged between an engine block and an engine bracket in order to measure a pressure generated between the engine block and the engine carrier. An electrical circuit generates a torque detection signal in reaction to a measurement signal generated by the pressure measurement device.

### SUMMARY OF INVENTION

The present invention is based on an object of providing an improved method for determining the power of a turbomachine, and a turbomachine.

This object is achieved by way of a power determination method, and a turbomachine according to the independent claims. Advantageous refinements of the invention are specified in the subclaims and described in the description.

In the method according to the invention for determining a power of a turbomachine which, in its interior, comprises a turbine housing which is supported with respect to a torque, present load-bearing forces of the turbine housing are firstly determined, and differences with respect to stored permanent load-bearing forces are subsequently calculated. The torque is then determined as a sum of said differences, and the power of the turbomachine is determined from said torque.

Thus, a method is provided which can be easily implemented and which provides a relatively accurate value for the power of the turbomachine.

In an advantageous embodiment of the method according to the invention, an elastic deformation of carrier elements of the turbine housing is determined. The present load-bearing forces are then determined in each case from said deformation of the carrier elements.

It is thus possible in particular to take advantage of the construction principle of the low-pressure turbines with housing carrier arms. According to the invention, it is the case in particular that strain gauges are used for this purpose.

In a further advantageous embodiment of the method according to the invention, a relationship between the deformation of the carrier elements and the present load-bearing forces is determined through the application of a predefined force.

The elastic deformation of the carrier elements varies linearly with the additional force applied. It is thus possible to perform calibration of the sensors, and improve the measurement result.

In a further advantageous embodiment of the method according to the invention, the predefined force is generated by an application of a known negative pressure in the interior of the turbomachine in combination with the interior being sealed with respect to the surroundings. In this way, the ambient pressure acts, on a surface area of known size, as an additional force on the turbine housing. The surface area on which the ambient pressure acts corresponds to the cross section of the inflow pipe of the turbine housing.

Thus, to apply the additional force, it is possible to use devices, such as an evacuation device, which are already provided for other purposes on many turbomachines, in particular steam turbines. Implementing the calibration is thus greatly simplified.

The turbomachine according to the invention has an interior and a turbine housing which is arranged in the interior, wherein the turbine housing has a central axis and multiple carrier elements arranged spaced apart from the central axis, by means of which carrier elements the turbine housing is supported with respect to a torque acting about the central axis. According to the invention, each carrier element is assigned a sensor for determining a present load-bearing force acting on the carrier element. The sensors are connected to an evaluation unit. The evaluation unit is designed to carry out the method according to the invention.

Thus, a turbomachine for carrying out the method according to the invention is provided, the power of which turbomachine can be easily determined.

In an advantageous refinement of the turbomachine according to the invention, the sensor is in each case a force measurement sensor arranged at a load-bearing position of the carrier element.

The load-bearing forces can thus be directly measured. Conversion from other variables is not necessary.

In an alternative refinement of the turbomachine according to the invention, the sensor is in each case a strain gauge positioned on the carrier element.

The strain gauges can be easily applied, even retroactively, and are relatively inexpensive. The turbomachine is thus prepared in a simple and inexpensive manner for the method according to the invention.

In a further advantageous refinement of the turbomachine according to the invention, the turbomachine comprises an evacuation device for generating a negative pressure in the interior, and an inflow compensator for sealing off the interior with respect to the surroundings.

Such inflow compensators and evacuation machines are already provided for other purposes in various turbomachine configurations. Evacuation devices are widely used in particular in the case of steam turbines. The turbomachine consequently does not need to be equipped with additional components in order to be able to perform power determination in accordance with this invention.

### BRIEF DESCRIPTION OF THE DRAWINGS

Exemplary embodiments of the invention will be discussed in more detail on the basis of the drawings and the following description. In the drawings:

FIG. 1 shows a turbo set with a turbomachine according to the invention,

FIG. 2 shows a turbine housing of a turbomachine according to the invention,

FIG. 3 shows a carrier element of the turbine housing of the turbomachine according to the invention, and

FIG. 4 shows a power determination method according to the invention.

### DETAILED DESCRIPTION OF INVENTION

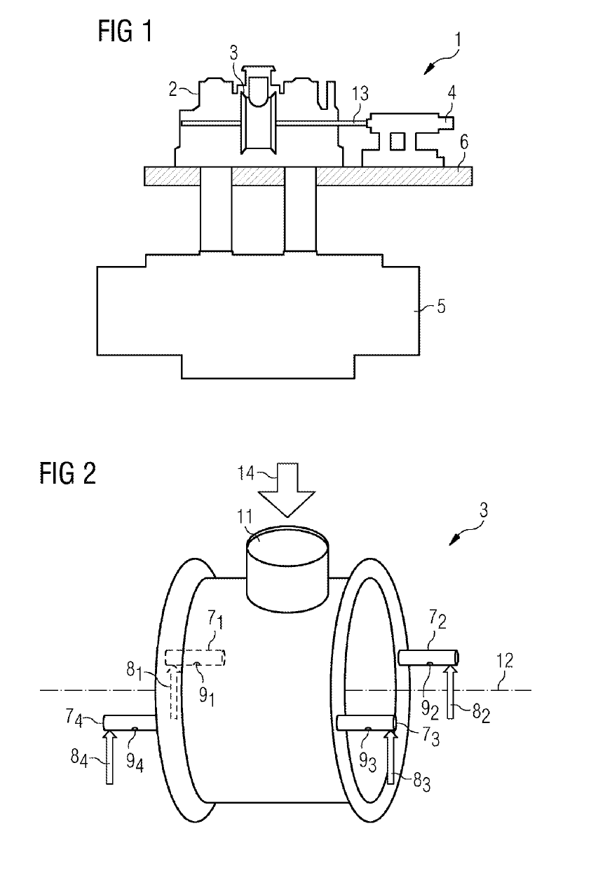

A turbo set 1 is depicted by way of example in FIG. 1. The turbo set 1 which is shown comprises a turbomachine 2 according to the invention and a generator 4 which is connected to the turbomachine 2 by way of a shaft 13. The shaft 13 is mounted in multiple bearings 16. The turbomachine 2 and the generator 4 are arranged on a foundation 6. The turbomachine 2 is in particular a steam turbine 2, the exhaust steam of which is received by a condenser 5.

The turbomachine 2 according to the invention has an interior. A turbine housing 3 is arranged in the interior.

Furthermore, the turbomachine 2 has an inlet opening through which steam can enter the turbine housing 3 during the operation of the turbomachine 2.

The turbine housing 3 is depicted by way of example in FIG. 2. The turbine housing 3 is arranged around a central axis 12. If, as in the exemplary embodiment, the turbomachine 2 is a steam turbine 2, the turbine housing 3 has an inflow pipe in the upper region. An inflow compensator 11 connects the inflow pipe of the turbine housing 3 to the inlet opening of the turbomachine 2 in such a way that the interior of the turbomachine 2 is sealed off with respect to the surroundings at this location. At the same time, the inflow compensator 11 ensures the mobility of the turbine housing 3 within the turbomachine 2. The inflow compensator 11 is a flexible connecting piece between the turbine housing 3 and turbomachine 2.

In particular, the turbine housing 3 accommodates guide vanes and is arranged around a rotor which is not shown in any more detail here and which is equipped with rotor vanes. During the operation of the turbomachine 2, the rotor rotates about the central axis 12 and drives the shaft 13, which transmits a torque 23 to the generator 4.

According to the invention, the turbine housing 3 has multiple carrier elements 7. The turbine housing 3 is mounted by way of the carrier elements 7. The carrier elements 7 are arranged spaced apart from the central axis 12. Thus, the turbine housing 3 is also supported with respect to torques which act about the central axis during the operation of the turbomachine 2. FIG. 2 shows, by way of example, four carrier elements 7₁, 7₂ , 7₃, 7₄, which are in the form of carrier arms. In FIG. 2, the carrier elements 7 are for example arranged at the face sides. The carrier elements 7 may also be positioned laterally or at the face sides and laterally. The carrier elements 7 are mounted on support bearings (not shown in any more detail here) which are shaped and dimensioned correspondingly.

According to the invention, each of the carrier elements 7₁, 7₂, 7₃, 7₄ has a sensor 9₁, 9₂, 9₃, 9₄. By means of the sensors 9₁, 9₂, 9₃, 9₄, it is possible at all of the carrier elements 7₁, 7₂, 7₃, 7₄ to determine present load-bearing forces 8₁, 8₂, 8₃, 8₄ that are acting on the carrier elements 7₁, 7₂, 7₃, 7₄ at the present point in time. A present load-bearing force 8 acts at each of the carrier elements 7, respectively. The sensors 9 are connected to an evaluation unit (not shown).

The present load-bearing forces 8 increase if, by way of an evacuation unit which is not illustrated in any more detail here, a pressure lower than ambient pressure is generated in the turbine housing 3. The surface area corresponding to the cross section of the inflow compensator 11 is then acted on by an ambient pressure 14, as positive pressure, in addition to the weight load of the turbine housing 3. This fact is utilized in the method 20 according to the invention.

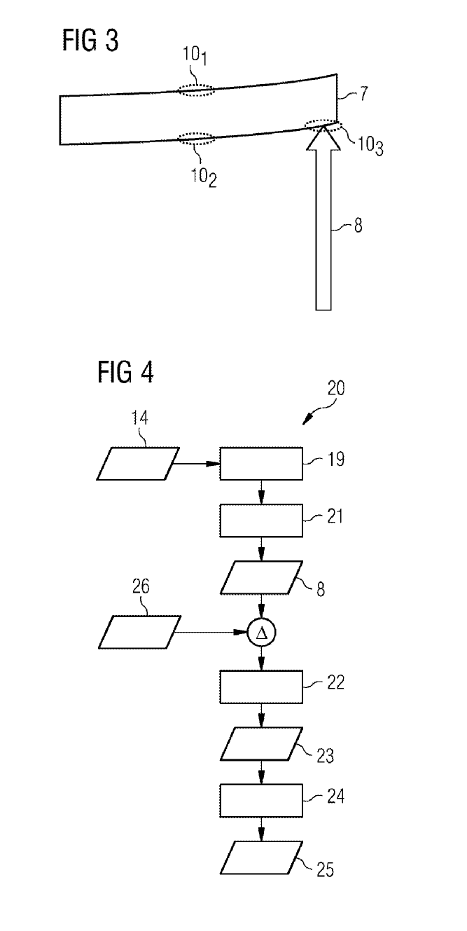

FIG. 3 depicts, by way of example, one of the carrier elements 7 under the influence of the present load-bearing force 8. In this state, the carrier element 7 is elastically deformed. The illustrated deformation is shown on a greatly exaggerated scale.

Possible sensor positions 10 are shown by way of example in FIG. 3. In a first variant of the turbomachine 2 according to the invention, the sensors 9 can directly determine the present load-bearing force 8 on the respective carrier element 7. For this purpose, the sensor 9 is in each case arranged directly at a load-bearing position 10₃ of the carrier element 7. In this case, the sensor 9 is for example a piezo element, a load cell or else a thin-film sensor. Furthermore, in a second variant of the turbomachine 2 according to the invention, the present load-bearing force 8 may also be determined through determination of the deformation of the carrier element 7. For this purpose, the sensor 9 is then arranged on the carrier element 7 in each case at a position of tensile strain 10₂ or else at a position of compressive strain 10₁. The sensor 9 is in this case in particular a strain gauge. The two variants may also be used simultaneously.

The present load-bearing force 8 at each carrier element 7 has a different value during the operation of the turbomachine 2 than a permanent load-bearing force 26 at each carrier element 7 in the rest state of the turbomachine 2. In the method 20 according to the invention, the present power of the turbomachine 2 is determined from said difference between the present load-bearing force 8 and the permanent load-bearing force 26 at the individual carrier elements 7. The power determination method 20 according to the invention is illustrated by way of example in a diagram in FIG. 4.

In the method 20 according to the invention, it is firstly the case, in a load-bearing force determination step 21, that the present load-bearing force 8 acting at each carrier element 7 is determined. In this case, the present load-bearing force 8 may be determined by direct measurement of the present load-bearing force 8 by means of a force measurement sensor 9 arranged at the load-bearing position 10₃, or by indirect determination by means of a deformation sensor 9 which is arranged at the position of compressive strain 10₁ and/or at the position of tensile strain 10₂.

In a torque determination step 22, the torque 23 of the shaft 13 is then determined. For this purpose, it is firstly the case that, for each carrier element 7, a difference between the present load-bearing force 8 and the permanent load-bearing force 26 is calculated. This yields, as an intermediate value, a differential load-bearing force for each carrier element 7. Said differential load-bearing force yields in each case, together with the known spacing to the central axis 12, an individual torque. The sum of the individual elements yields the torque 23 of the shaft 13, as the magnitude of the torque 23 of the shaft is equal to the magnitude of a torque of the guide vanes, and the magnitude of the torque of the guide vanes is equal to the magnitude of a torque of the turbine housing 3.

In a power determination step 24, the power 25 of the turbomachine 2 is then determined. The power of the turbomachine 2 corresponds to a power of the shaft 13. The power of the shaft 13 is determined from a product of the torque 23 of the shaft 13 and the present angular speed of the shaft.

In particular if the load-bearing force determination step 21 is performed by monitoring of the deformation of the carrier elements 7, it is possible according to the invention, before the load-bearing force determination step 21, to determine a relationship between the deformation of the carrier elements 7 and an additionally applied force in order to perform a calibration 19 of the sensors 9. For this purpose, it is the case in particular that a negative pressure is applied in the turbine housing 3. Owing to the decrease of the pressure in the turbine housing 3, the turbine housing 3 is acted on by the ambient pressure 14 as positive pressure. In this case, the ambient pressure acts on the surface area of the cross section of the inflow compensator 11. Since the effected pressure difference between turbine housing pressure and ambient pressure 14 and the cross-sectional area of the inflow compensator 11 are known, the force additionally acting on the turbine housing is also known. The additional force and the elastic deformation of the carrier elements 7 vary linearly with respect to one another. This possibility for calibration 19 exists in particular, for reasons relating to type of construction, in the case of steam turbines 2 which are already assigned evacuation devices for the actual operation thereof.

Although the invention has been described and illustrated in more detail by way of the preferred exemplary embodiment, the invention is not restricted by the disclosed examples and other variations can be derived herefrom by a person skilled in the art without departing from the scope of protection of the invention.

1. A method for determining a power of a turbomachine which, in its interior, has a turbine housing which is supported with respect to a torque, the method comprising:
determining present load-bearing forces of the turbine housing,
calculating differences with respect to stored permanent load-bearing forces,
determining the torque as a sum of said differences, and
determining the power of the turbomachine from said torque.

2. The method as claimed in claim 1, further comprising
determining an elastic deformation of carrier elements of the turbine housing,
wherein the present load-bearing forces are determined in each case from the elastic deformation of the carrier elements.

3. The method as claimed in claim 2, further comprising
determining a relationship between the deformation of the carrier elements and the present load-bearing forces through the application of a predefined force.

4. The method as claimed in claim 3, further comprising
generating the predefined force by an application of a known negative pressure in the interior of the turbomachine in combination with the interior being sealed with respect to the surroundings.

5. A turbomachine comprising:
a turbine housing which is arranged in an interior of the turbomachine,
wherein the turbine housing has a central axis and multiple carrier elements arranged spaced apart from the central axis, by means of which carrier elements the turbine housing is supported with respect to a torque acting about the central axis,
wherein each carrier element is assigned a sensor for determining a present load-bearing force acting on the carrier element,
and the sensors are connected to an evaluation unit which is adapted to carry out the method as claimed in claim 1.

6. The turbomachine as claimed in claim 5,
wherein the sensor is in each case a force measurement sensor arranged at a load-bearing position of the carrier element.

7. The turbomachine as claimed in claim 5,
wherein the sensor is in each case a strain gauge positioned on the carrier element.

8. The turbomachine as claimed in claim 5, wherein the turbomachine further comprises
an evacuation device for generating a negative pressure in the interior, and
an inflow compensator for sealing off the interior with respect to the surroundings.

9. The turbomachine as claimed in claim 5,
wherein the turbomachine is a steam turbine.
